(19) United States
(12) Patent Application Publication
(10) Pub. No.: US 2002/0099856 A1
(43) Pub. Date: Jul. 25, 2002

(54) Information processing device and method thereof, recording medium and program

(76) Inventor: Kazuhiro Shitama, Chiba (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/043,189

(22) Filed: Jan. 10, 2002

(30) Foreign Application Priority Data
Jan. 15, 2001 (JP) P2001-006364

(51) Int. Cl. G06F 15/16; H04L 12/28

(52) U.S. Cl. 709/249; 370/351

(57) ABSTRACT

Information processing device, recording medium and program capable of supporting node movement. A router receives a data packet sent from a node positioned within the same domain and extracts the lower 64 bits of the IPv6 address listed in the end-point address field of that data packet. The router then refers to the routing table and checks whether or not a host entry relating to the interface ID listed in the extracted lower 64 bits is present. When determined that a host entry is present, a data packet is sent.

### BACKGROUND OF THE INVENTION

1. Field of the Invention

The present invention relates to an information processing device, method thereof, recording medium and program and relates in particular to an information processing device, method thereof, recording medium and program for supporting node movement.

2. Description of the Related Art

Along with the widespread use of portable type personal computers in recent years, personal computers are now portable and can be carried by the user. Not limited to simply being carried or brought along by the user, these portable type personal computers can also be connected to the network at the movement destination for receiving various services on the network.

In a mobile computing environment of this kind, the nodes that constitute the device (personal computer) receiving a service while connected to a network must be mobile. These nodes must be capable of continuous communication even if the node position changes.

To achieve mobile transparency in IPv6 network layers, VIPv6 in patent application No. 2000-000560 and Mobile IPv6 by the IETF (Internet Engineering Task Force) were proposed based on the current IPv6 (Internet Protocol Version 6).

However, in both the Mobile IPv6 and VIPv6 protocols, each time the node moved between subnetworks, the change in node position had to be reported to the server (in other words, the home agent in the case of mobile IPv6, and the mapping agent in the case of VIPv6) controlling that node's position information.

Many movement report messages (messages reporting the new position of the node) were therefore issued when a node often changed position, causing the problem that a load was placed on the network.

Also, when the server controlling the position information, was located far away from the mobile node on the network, much time was required for the server to receive the movement report message and rewrite the position information.

The IETF there upon proposed a number of methods to resolve the above problems. The Mobile IPv6 and VIPv6 protocols were called macromobility protocols while the method proposed here is called a micromobility protocol.

However, IP-in-IP tunneling was utilized in currently proposed micromobility protocol methods, so that header size and header processing were extremely inefficient, and the characteristic of the 32 bit (4 byte) address in IPv4 was used unchanged in IPv6 expanded to 128 bit (16 bytes) so that the address structure of the “network prefix+interface ID) of the IPv6 address could not be properly utilized.

### SUMMARY OF THE INVENTION

In view of the above problems with the related art, the present invention has the object of providing a means capable of supporting node movement by utilizing the structure of the IPv6 address.

The information processing device of the present invention is characterized in comprising a memory storage means to match identification information designating a terminal device with position information specifying the current position of the terminal device and store the information, a decision means to determine whether or not identification information specifying the transfer destination of the terminal device contained in received data is stored in the memory storage means, and a transfer means to transfer data to a specified first network (in a second network) holding the terminal device based on stored position information linked to the identification information, when the result from the decision means is that identification information is stored in the memory storage means.

The first network is a subnetwork, and the second network is a domain.

The identification information constitutes an interface ID specifying the terminal device, and the position information constitutes a unique address within the second network.

When results from the decision means are that identification information is not stored in the memory storage means, the transfer means transfers the data to a fourth network constituting an aggregate of a plurality of third networks.

The third networks are subnetworks and the fourth network is a domain.

The information processing method of the present invention is characterized in comprising a memory storage step to match identification information designating a terminal device with position information specifying the current position of the terminal device and store the information, a decision step to determine whether or not identification information specifying the transfer destination of the terminal device contained in received data was stored in the memory storage step, and a transfer step to transfer data to a specified first network (in a second network) holding the terminal device based on stored position information linked to the identification information, when results from the decision step are that identification information was stored in the memory storage step.

A program recorded on the recording medium of the present invention, is characterized in comprising a memory storage step to match identification information designating a terminal device with position information specifying the current position of the terminal device and store the information, a decision step to determine whether or not identification information specifying the transfer destination of the terminal device contained in received data was stored in the memory storage step, and a transfer step to transfer data to a specified first network (in a second network) holding the terminal device based on stored position information linked to the identification information, when results from the decision step are that identification information was stored in the memory storage step.

A program of the present invention run on a computer is characterized in comprising a memory storage step to match identification information designating a terminal device with position information specifying the current position of the terminal device and storing the information, a decision step to determine whether or not identification information specifying the transfer destination of the terminal device contained in received data was stored in the memory storage step, and a transfer step to transfer data to a specified first network (in a second network) holding the terminal device based on stored position information linked to the identification information, when results from the decision step are that identification information was stored in the memory storage step.

The information processing device, method thereof, and program of the present invention are capable of efficiently supporting node movement by matching identification information designating a terminal device with position information specifying the current position of the terminal device and storing the information, determining whether or not identification information specifying the transfer destination of the terminal device contained in received data was stored in the memory storage step, and transferring data to a specified first network (in a second network) holding the terminal device based on stored position information linked to the identification information, when results from the decision step are that identification information was stored in the memory storage step.

### BRIEF DESCRIPTION OF THE DRAWINGS

FIG. 1 is drawing showing the format structure of the IPv6 address of the present invention.

FIG. 2 is a drawing showing a typical structure of the embodiment of the network system applicable to the present invention.

FIG. 3 is a block diagram showing a typical internal structure of the domain boundary router of FIG. 2.

FIG. 4 is a drawing showing the routing table.

FIG. 5 is a flow chart showing the packet transfer process.

FIG. 6 is a drawing showing the data transfer packet process by host routing.

FIG. 7A through 7C are drawings showing the routing table.

### DETAILED DESCRIPTION OF THE PREFERRED EMBODIMENTS

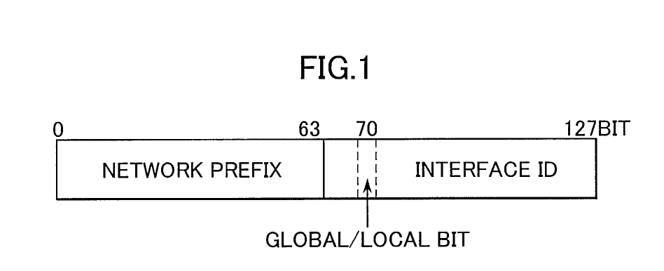

The embodiments of the present invention are hereafter described while referring to the accompanying drawings. FIG. 1 is a drawing showing the format structure of the IPv6 address related to the present invention.

The IPv6 address is composed of 128 bits as shown in FIG. 1. The upper 64 bits of the IPv6 address are called the network prefix and the lower 64 bits are called the interface ID. The network prefix usually indicates the position indicator showing the network connected to the node, and the interface ID within the subnetwork, indicates a position identifier for identifying the node interface.

The interface ID contains a global/local bit (70th bit in FIG. 1). A global/local bit of “1” indicates that interface ID is unique to the entire Internet. A global/local bit of “0” indicates that interface ID is unique within the subnetwork.

In the present invention, the micromobility protocol utilizes the feature that the IP address comprises two functions consisting of the network prefix and the interface ID as shown in FIG. 1.

Ranking above a subnet, a domain consists of a plurality of subnetworks. The network prefixes of the IPv6 address are assigned to domains (units) rather than subnetworks (units) as in the conventional method. In other words, the same network prefixes are assigned to subnetworks belonging to the same domain.

Therefore, since there is no change in the network prefix of the IPv6 address, even if the node moves within the domain there is no need to send a movement report message to the server (such as the home agent or mapping agent) controlling the node position information. So the movement report message is only issued when that node has moved to a different domain and the movement report is sent to the server controlling the position information.

Movement report messages that accompany frequent node movement therefore no longer have to be issued in large numbers and the load applied on the network is removed.

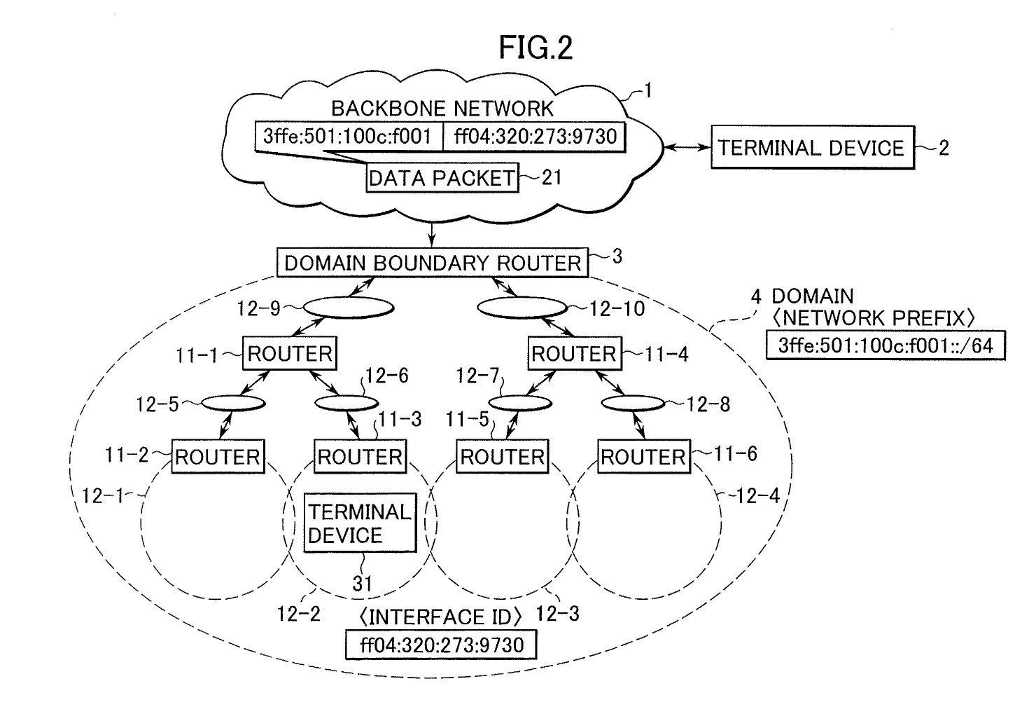

The structure of an embodiment of the network system of the present invention is shown in FIG. 2. In the network system in FIG. 2, the nodes comprising the network communicate based on the IPv6 address shown in FIG. 1.

The domain 4 is composed of a plurality of subnetworks 12-1 through 12-10. The subnetworks 12-1 through 12-10 are made up of communication media such as cable/wireless, or joint media/point-to-point media. Further, the subnetworks 12-1 through 12-4 are capable of connecting with a plurality of terminal devices (mobile nodes). The routers 11-1 through 11-6 are present within the domain 4, and form a tree structure with the domain boundary router 3 as the base. However, this is a theoretical topology and there is no need to form the actual topology as a tree structure.

The terminal device 2 is connected to the backbone network 1 and communicates with the terminal device 31 in the domain 4 via the backbone network 1 and domain boundary router 3.

The domain boundary router 3 is connected to the router 11-1 and 11-4 inside the domain 4. The routers 11-2 and 11-3 are connected to the router 11-1, and the routers 11-5 and 11-6 are connected to the router 11-4. The domain boundary router 3 and the routers 11-1 through 11-6 store the network prefixes, and control (routing) the transmit path of data packets supplied from mobile nodes such as terminal device 31 as well as the data packet 21 supplied from the terminal device 2.

The routing is explained next. Routing is performed for example, on the backbone network 1, based on the upper 64 bits (network prefix of the domain 4 connected to the mobile node) of the IPv6 address listed in the end-point address field of the IPv6 header of the data packet 21 for sending to the mobile node (terminal device 31 in the example in FIG. 2). Also, host routing is performed in the domain 4 using the lower 64 bits (mobile node interface ID) of the IPv6 address listed in the end-point address field of the IPv6 header of data packet 21 for sending to the mobile node.

By using the lower 64 bits making up the interface ID in the IPv6 address, as the host ID for host routing in this way, the routing within the domain 4 can be performed with a host base rather than the conventional network prefix base, and the routers 11-1 through 11-6 within the domain 4 can change paths with extremely little delay even for nodes (terminal device 31 in the example in FIG. 2) that move frequently.

However, the micromobility protocol of the present invention requires that the interface ID within the IPv6 address be unique at least within the domain 4. Therefore, when the global/local bit in the interface ID is set to a “1” the interface ID is unique within the entire Internet so there is no problem, but when the global/local bit is set to a “0”, an interface ID must be assigned to the mobile node (terminal device 31 in the example in FIG. 2) that is connected to be unique within domain 4. In one method to assign the interface ID, a domain boundary router 3 has unified control of interface IDs within domain 4, and when a mobile node makes a new connection to domain 4, the domain boundary router 3 assigns an interface ID to the mobile node after performing verification.

Micromobility can therefore be achieved in the present invention in this way, by host routing within the domain 4 using the lower 64 bits (in other words, the interface ID) of the IPv6 address listed in the end-point address field of the data packet 21 sent to the mobile node. So none of the other methods proposed for micromobility protocols such as inefficient IP-in-IP tunneling are used, and routing with the backbone network 1 can be performed with a network prefix base just as used in the conventional art so there is no need to add special functions to the router (not shown in drawing) on the backbone network 1.

Returning to the explanation of FIG. 2, when positioned within the subnetwork 12-1, the terminal device 31 constituting the mobile node connects to the router 11-2 and router 11-1 via the specified communications media; and connects to the backbone network 1 via and the domain boundary router 3.

When positioned within the subnetwork 12-2, the terminal device 31 constituting the mobile node connects to the router 11-3 and router 11-1 via the specified communications media; and connects to the backbone network 1 via and the domain boundary router 3.

When positioned within the subnetwork 12-3, the terminal device 31 constituting the mobile node connects to the router 11-5 and router 11-4 via the specified communications media; and connects to the backbone network 1 via and the domain boundary router 3.

When positioned within the subnetwork 12-4, the terminal device 31 constituting the mobile node connects to the router 11-6 and the router 11-4 via the specified communications media; and connects to the backbone network 1 via and the domain boundary router 3.

In the example in FIG. 2, the terminal device 31 connects to the subnetwork 12-2 with router 11-3 as the default router.

The routers 11-1 through 11-6 respectively control the transmission paths for data packets supplied from the mobile nodes such as terminal device 31 as well as the data packet 21 supplied from the terminal device 2. The routers 11-1 through 11-6 are referred to hereafter simply as router 11 when there is no need to refer to them individually.

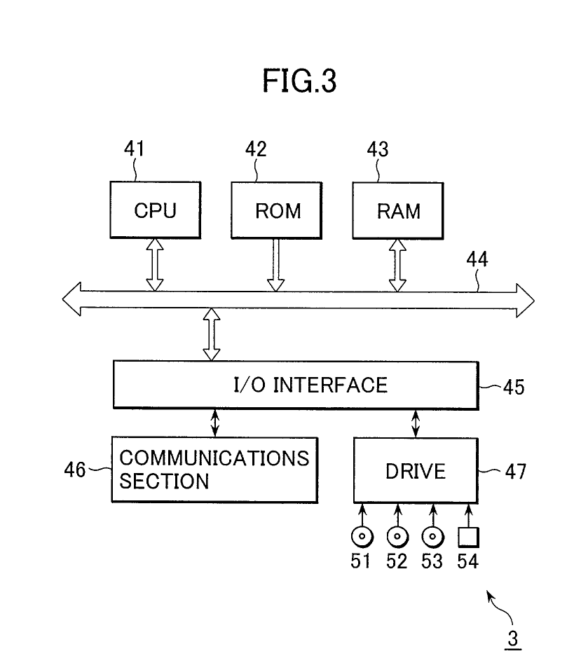

FIG. 3 is a block diagram showing the internal structure of the domain boundary router 3 of FIG. 2.

A CPU 42 runs the various processing according to the program loaded in the RAM (Random Access Memory) 43 from the program stored in the ROM (Read Only Memory) 42. The ROM 42 generally stores processing parameters and fixed data from among programs to run on the CPU 41. The RAM 43 stores programs to run on the CPU 41 and rewritable parameters for running those programs.

The CPU 41, ROM 42 and RAM 43 are mutually connected by way of a bus 44. This bus 44 also connects to the I/O interface 45.

A communications section 46 connects to the I/O interface 45, and runs communications processing by way of the a backbone network 1 such as the Internet. The communications section 46 is connected to a network such as the Internet, and stores data supplied from the CPU 41 in data packets of a specified type and transmits them, or outputs data stored in received data packets to the CPU 41.

A drive 47 is connected to the I/O interface 45 as needed, and a magnetic disk 51, optical disk 52, magneto-optic disk 53 or a semiconductor memory 54 are connected as needed, and a computer program loaded from these components is supplied to the ROM 42 as necessary.

The routers 11-1 through 11-6 have the same structure as the domain boundary router 3 shown in FIG. 2 so an explanation is omitted here.

The operation of the above embodiment is described next.

The operation when the terminal device 2 sends the data packet 21 to the terminal device 31 constituting the mobile node is described first.

An interface ID of “ff04: 320: 273: 9730” is stored in the terminal device 31 as shown in FIG. 2. A network prefix of “3ffe: 501: 100c: f001: : /64” is assigned to the domain 4.

The IPv6 address of terminal device 31 which is “3ffe: 501: 100c: f001: ff04: 320: 273: 9730” (network prefix of domain 4+interface ID of terminal device 31) is listed in the header end-point address field of data packet 21 addressed to the terminal device 31 sent from the terminal device 2. In the backbone network 1, the data packet 21 sent from terminal device 2 is routed based on the upper 64 bits of the network prefix (3ffe: 501: 100c: f001: : /64) in this IPv6 address, and then transferred to the domain boundary router 3.

The data packet 21 sent from the terminal device 2 is host routed and transferred to the terminal device 31 by way of the domain boundary router 3 and the routers 11-1 and 11-3 based on the lower 64 bit interface ID (ff04: 320: 273: 9730) of the IPv6 address listed in the header end-point address field of data packet 21 sent from the terminal device 2 by way of the backbone network 1.

An optimum path is therefore used, based on the IPv6 address listed in the header end-point address field of the data packet when sending a data packet 21 in this way from the terminal device 2 to the terminal device 31 constituting the mobile node.

The operation when a mobile node connected to a domain (for example, domain A) sends a data packet is described next.

The network prefix of the connected domain A is listed in the upper 64 bits of the IPv6 address of the header start-point address field of the data packet sent from the mobile node connected to domain A, and the interface ID of that node is listed in the lower 64 bits.

In the example in FIG. 2, the IPv6 address, “3ffe: 501: 100c: f001: ff04: 320: 273: 9730” (network prefix of domain 4+interface ID of terminal device 31) of terminal device 31 is listed in the header start-point address field of the data packet sent from the mobile node constituted by terminal device 31, and the destination node of IPv6 address is listed in the end-point address field.

When the destination node listed in the header end-point address field of the data packet that was sent is connected within the same domain as the mobile node (in other words, having the same upper 64 bit network prefix), then host-routing is implemented by each router within the same domain based on the lower 64 bit (interface ID) of the destination node IPv6 address.

However, when the destination node is not connected within the same domain name as the mobile node (in other words, having a different upper 64 bit network prefix), then routing is performed up to the domain boundary router 3 (in the example in FIG. 2, on a path from terminal device 31 to router 11-3, router 11-1 and domain boundary router 3); and routing is further implemented from the domain boundary router 3 to the latter stage of backbone network 1 based on the upper 64 bits (network prefix) of the destination node IPv6 address.

Host routing within domain 4 based on the interface ID is described next in detail.

Each router (router 11-1 through 11-6 and domain boundary router 3) within the domain 4 contains a routing table for host routing of the mobile node (terminal device 31).

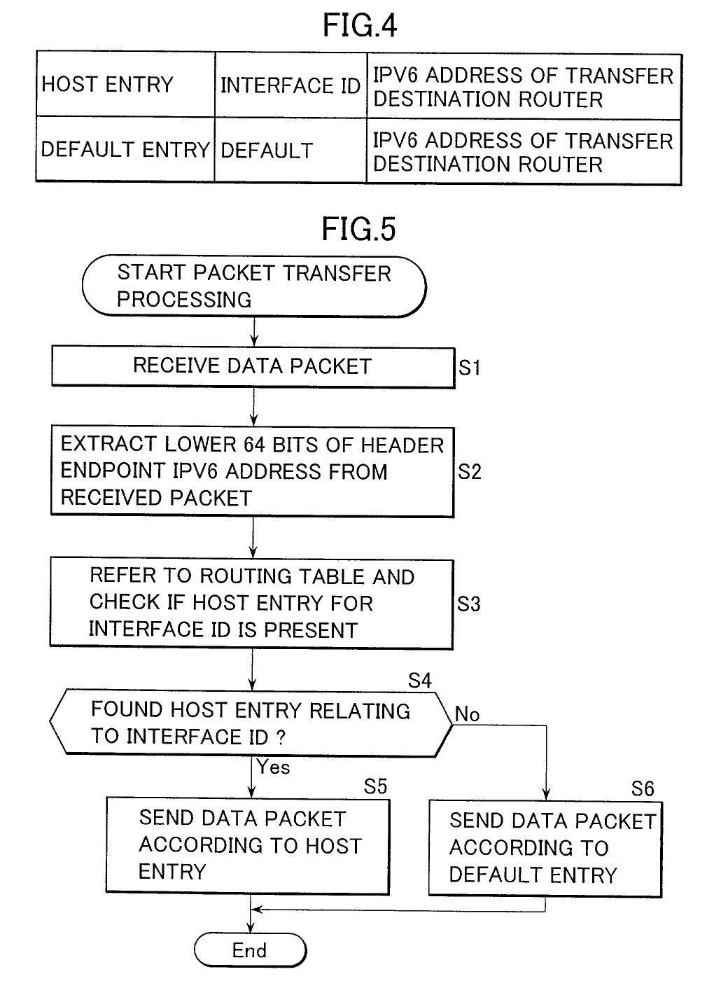

The routing table is composed of a host entry and default entry as shown for example in FIG. 4. The IPv6 address of the next transfer router for sending (forwarding) the data packet shown in the interface ID as well as that interface ID are listed in the host entry. However, when capable of being sent directly to the destination node, then “on-link” is listed in the IPv6 address of the router for the next transfer. The IPv6 address of the next transfer router for sending (forwarding) a data packet with no match in the host entry is listed in the default entry.

The router address referred to here, may be the IPv6 link local address assigned to the network interface of the router, or may be an IPv6 site local address.

When the router (router 11-1 through 11-6 and domain boundary router 3) receives a data packet from the mobile node, the routing table controlled by that router is searched, and a check made to find whether or not a host entry matching the destination node interface ID listed in the lower 64 bits of the end-point address field of the data packet is present. When determined that a host entry matching the interface ID of the destination node is present, then that data packet is transferred to the router indicated in that host entry. However, when determined that there is no host entry matching the interface ID of the destination node, then that data packet is sent to the router shown in the default entry.

To further clarify the sequence of the above described processing, the transfer process for routing a data packet with routers inside the same domain is described next while referring to the flowchart of FIG. 5.

In step S1, the router 11 and the domain boundary router 3 receive the data packet. In step S2, the lower 64 bits of the IPv6 address listed in the header end-point address field of the data packet received in the processing in step S1, is extracted by the router 11.

In step S3, based on the destination node interface ID listed in the lower 64 bits of the IPv6 address extracted in the processing of step S2, the router 11 and the domain boundary router 3 refer to the routing table (FIG. 4) and check whether or not a host entry relating to the interface ID is present.

In step S4, based on the check results in the processing of step S3, the router 11 and the domain boundary router 3 decide whether or not the routing table contains a host entry relating to the interface ID. When determined that a host entry relating to the interface ID is present, the process proceeds to step S5. In step S5, the router 11 and the domain boundary router 3 send the received packet to the router shown in the host entry listed in the routing table.

In step S4, when there is no host entry relating to the interface ID, in other words, when determined to be in the default entry, the process proceeds to step S6, and the router 11 and the domain boundary router 3 send the received data packet to the router shown in the default entry listed in the routing table and the processing is terminated.

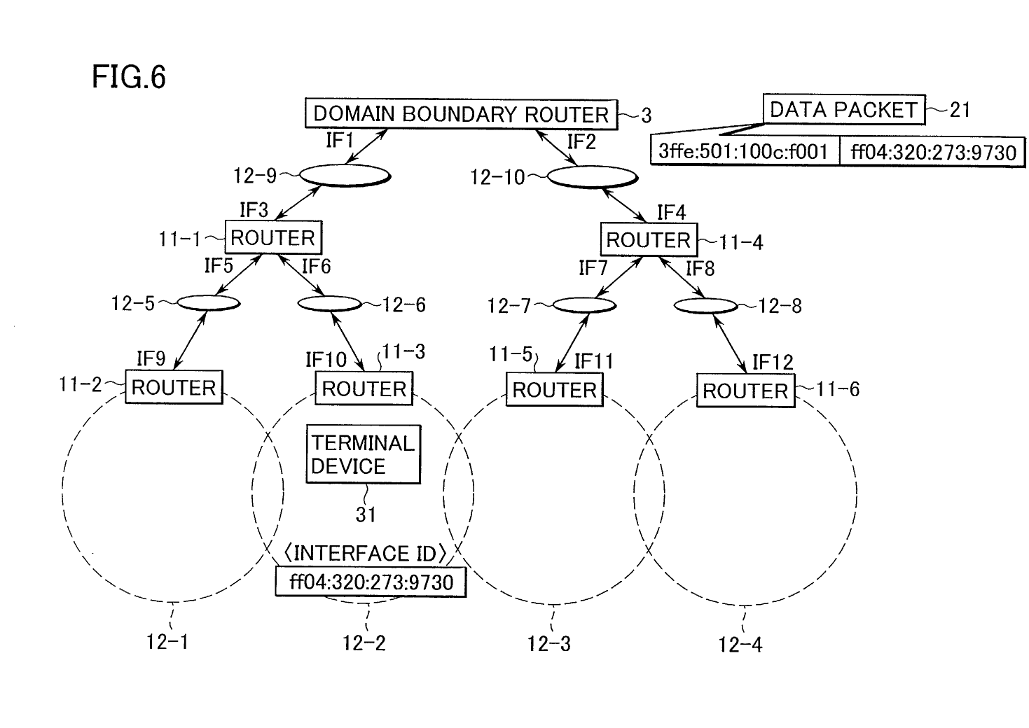

The process for the domain boundary router 3 to receive the data packet 21 addressed to the terminal device 31, and send it to the terminal device 31 by host routing is explained next while referring to FIG. 6.

The internal structure of the domain 4 is shown in FIG. 6. A network prefix of “3ffe: 501: 100c: f001: : /64” is assigned to the domain 4. In the figure, IF1 through IF12 indicate the IPv6 addresses assigned to each router and network within the domain 4. The mobile node constituted by terminal device 31 is connected to a subnetwork 12-2 using the router 11-3 as a default router, and an interface ID of “ff04: 320: 273: 9730” is stored in the terminal device 31.

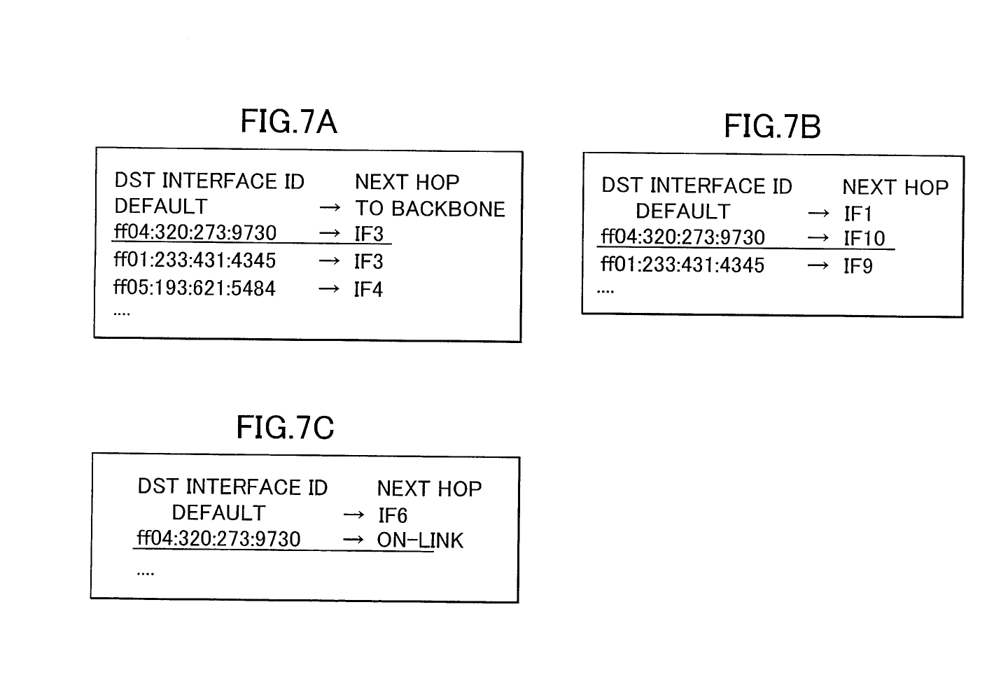

The domain boundary router 3 controls a routing table such as shown in FIG. 7A. The router 11-1 controls a routing table such as shown in FIG. 7B. The router 11-3 controls a routing table such as shown in FIG. 7C.

An IPv6 address “IF3” of the next router to transfer (hop) to, in order to forward the node packet shown by the interface ID, “ff04: 320: 273: 9730” is paired with that interface ID and listed in the host entry in the routing table shown in FIG. 7A. An IPv6 address “IF3” for the next router to transfer to, in order to forward the node packet shown by the interface ID, “ff01: 233: 431: 4345” is paired and listed with that interface ID. An IPv6 address “IF4” for the next router to transfer to, in order to forward the node packet shown by the interface ID, “ff05: 193: 621: 5484” is paired and listed with that interface ID. Further, data packets not matched with a host entry are paired and listed with the IPv6 address “to Backbone” of the next router to transfer (hop) to in “default” of the default entry.

An IPv6 address “IF10” of the next router to transfer to, in order to forward the node packet shown by the interface ID, “ff04: 320: 273: 9730” is paired with that interface ID and listed in the host entry in the routing table shown in FIG. 7B. An IPv6 address “F9” for the next router to transfer to, in order to forward the node packet shown by the interface ID, “ff01: 233: 431: 4345” is paired with that interface ID and listed. Further, a data packet not matched with a host entry is paired and listed with the IPv6 address “IF1” of the next router to transfer to, in “default” of the default entry.

In FIG. 7C, “on-link” (capable of direct transfer to destination node) is paired with the interface ID “ff04: 320: 273: 9730” in the host entry of the routing table and listed. Further, a data packet not matched with a host entry is paired and listed with the IPv6 address “IF6” of the next router to transfer to, in “default” of the default entry.

Returning to FIG. 6, upon receiving the data packet 21 addressed to terminal device 31, the domain boundary router 3 refers to the routing table shown in FIG. 7A, and checks whether or not a host entry relating to the interface ID is present, based on the interface ID (ff04: 320: 273: 9730) of the lower 64 bits of IPv6 address “3ffe: 501: 100c: f001: ff04: 320: 273: 9730” listed in the header end-point address field of that data packet 21.

In the present case, the interface ID (ff04: 320: 273: 9730) for the lower 64 bits of the IPv6 address listed in the header end-point address field of the received data packet are stored in the host entry in the routing table (FIG. 7A) controlled by the domain boundary router 3, so that based on this host entry, the domain boundary router 3 transfers the received data packet 21 to the router 11-1 assigned with an IPv6 address of IF3.

When the data packet 21 addressed to the terminal device 31 is received, the router 11-1 refers to the routing table shown in FIG. 7B, and checks whether or not a host entry relating to the interface ID is present, based on the interface ID (ff04 320: 273: 9730) of the lower 64 bits of IPv6 address “3ffe: 501: 100c: f001: ff04: 320: 273: 9730” listed in the header end-point address field of that data packet 21.

In the present case, the interface ID (ff04: 320: 273: 9730) for the lower 64 bits of the IPv6 address listed in the header end-point address field of the received data packet is stored in the host entry in the routing table (FIG. 7B) controlled by the router 11-1, so that based on this host entry, the router 11-1 transfers the received data packet 21 to the router 11-3 assigned with an IPv6 address of IF10.

When the router 11-3 receives from the router 11-1, the data packet 21 addressed to terminal device 31, it refers to the routing table shown in FIG. 7C, and checks whether or not a host entry relating to the interface ID is present, based on the interface ID (ff04: 320: 273: 9730) of the lower 64 bits of IPv6 address “3ffe: 501: 100c: f001: ff04: 320: 273: 9730” listed in the header end-point address field of that data packet 21.

In the present case, the interface ID (ff04: 320: 273: 9730) for the lower 64 bits of the IPv6 address listed in the header end-point address field of the received data packet 21 is stored in the host entry in the routing table (FIG. 7C) controlled by the router 11-3, so that based on this host entry (since the terminal device 31 is known to connect to the subnetwork 12-2 using the router 11-3 as the default router), the router 11-3 directly transfers (sends) the received data packet 21 to the terminal device 31.

The making or rewriting of host entries within the routing table each time a node moves, is performed by the router inside the domain by receiving a control update called a routing update sent from that node. This making or rewriting of routing table in this way can use techniques such as utilized in Cellular IP or HAWAII.

Micromobility can be achieved by performing host routing within the domain by utilizing only the lower 64 bits (interface ID) of the IPv6 address listed in the end-point address field of the data packet addressed to the mobile node as described above, so that there is no need to utilize the upper 64 bits of the network prefix. The upper 64 bit portion of the IPv6 address can therefore be omitted from the data packet header within the domain. The overhead due to header size therefore becomes smaller, and data packets can be transferred more efficiently.

The routing within the backbone network 1 is performed using a network prefix the same as in the related art so that there is no need for adding special functions to the router (not shown in drawing) on the backbone network 1.

If an IPv6 version of Cellular IP or HAWAII is developed in the future, a Mobile IPv6 home address will probably be utilized in the host ID for host routing within the domain. However, the host ID utilized in host routing within the domain in the present invention is the lower 64 bits of the IPv6 address so that the size of the host entry of the routing table that must be controlled by each router within the domain is small. Therefore, the memory storage capacity for storing the routing table can be kept small.

Further, network prefixes are assigned to domains consisting of a plurality of subnetworks so that the possibility of all the network prefixes being used up is low compared to when network prefixes are assigned to subnetworks (units).

The above described processing can also be implemented by software. The program comprising that software may be installed as dedicated hardware incorporated into a computer or installed as various programs, or may be installed from a recording medium onto for example a personal computer capable of running various functions.

As shown in FIG. 3, the recording medium is comprised by a magnetic disk 51, (including program), an optical disk 52 (including CD-ROM (Compact Disk-Read Only Memory), DVD (Digital Versatile Disk)), a magneto-optic disk 53 (including MD (Mini-disk) , or a packaged media such as a semiconductor memory 54 separate from the computer and recorded with programs for distribution to the user.

In these specifications, the steps listing the programs recorded on the recording medium may of course be processed time-wise in the sequence that the steps are listed. However, the processing need not always be performed on a time-base and the step processing may be implemented in parallel or individually.

The term “system” as used in these specifications indicates the overall device or apparatus composed of a plurality of devices.

What is claimed is:

1. An information processing device for sending data to a terminal device connected to a second network made up of an aggregate of plural first networks, said device comprising:
memory storage means for storing information for identifying said terminal device paired with position information specifying the current position of said terminal device;
decision means for determining whether or not identification information specifying the terminal device of the transfer destination contained in said received data is stored in said memory storage means and,
transfer means for transferring said data to said specified first network holding said terminal device according to said stored position information paired with said identification information, when the result from said decision means is that said identification information is stored in said memory storage means.

2. An information processing device according to claim 1, wherein said first network is a subnetwork and said second network is a domain.

3. An information processing device according to claim 1, wherein said identification information is an interface ID specifying said terminal device, and said position information is a unique address within said second network

4. An information processing device according to claim 1, wherein said transfer means transfers said data to a fourth network made up of an aggregate of a plurality of third networks when result from said decision means is that said identification information is not stored in said memory storage means.

5. An information processing device according to claim 4, wherein said third networks are subnetworks and said fourth network is a domain.

6. An information processing method for an information processing device for sending data to terminal devices connected to a second network constituted as an aggregate of a plurality of first networks, said method comprising:
a memory storage step for storing information specifying a terminal device paired with position information specifying the current position of said terminal device;
a decision step for determining whether or not identification information specifying the terminal device of the transfer destination contained in said received data is stored in said memory storage step;
a transfer step for transferring said data to a specified first network holding said terminal device according to said stored position information paired with said identification information, when result from said decision step is that said identification information is stored in said memory storage step.

7. A recording medium having recorded thereon a computer-readable program for controlling an information processing device for sending data to terminal devices connected to a second network constituted as an aggregate of a plurality of first networks, said program comprising:
a memory storage step for storing identification information specifying a terminal device paired with position information specifying the current position of said terminal device;
a decision step for determining whether or not identification information specifying the terminal device of the transfer destination contained in received data is stored in said memory storage step, and
a transfer step for transferring said data to a specified first network holding said terminal device according to said stored position information paired with said identification information, when result from said decision step is that said identification information is stored in said memory storage step.

8. A program in a computer for controlling an information processing device for sending data to terminal devices connected to a second network made up of an aggregate of a plurality of first networks, said method comprising:
a memory storage step for matching identification information specifying a terminal device with position information specifying the current position of said terminal device and storing the information;
a decision step for determining whether or not identification information specifying the terminal device of the transfer destination contained in received data was stored in said memory storage step, and
a transfer step for transferring said data to a specified first network holding said terminal device based on said stored position information paired with said identification information, when result from said decision step is that said identification information is stored in said memory storage step.
